(19) United States
(12) Patent Application Publication
(10) Pub. No.: US 2009/0024268 A1
(43) Pub. Date: Jan. 22, 2009

(54) VEHICLE DIAGNOSTIC LISTENING DEVICE AND METHOD THEREFOR

(76) Inventor: Chris Eagan, Las Vegas, NV (US)

Correspondence Address: WEISS & MOY PC, 4204 NORTH BROWN AVENUE, SCOTTSDALE, AZ, 85251, US

(21) Appl. No.: 11/779,708

(22) Filed: Jul. 18, 2007

(51) Int. Cl. G01M 17/00

(52) U.S. Cl. 701/29

(57) ABSTRACT

A diagnostic listening device for a vehicle uses at least one input device to retrieve audible signals from the vehicle. Diagnostic circuitry is coupled to the at least one input device to allow a user to listen to the audible signals retrieved and to isolate out certain frequencies to aid in the diagnosis of the vehicle.

### FIELD OF THE INVENTION

This invention relates generally to the automotive industry and, more specifically, to a vehicle maintenance device which is used for acoustical sensing and vibration sensing during the inspection/repair of a vehicle.

### BACKGROUND OF THE INVENTION

Vehicle inspection is important in order for a vehicle to run properly. To properly inspect the engine, transmission, differential, or other system of a vehicle, one must use some type of listening device to see if these systems, or components of these systems, are functioning properly. The listening device is generally used to receive audio sounds and vibrations to see if a certain component is running smoothly, whether a component is leaking, and the like.

Presently, there are devices which allow a user to listen to engine noise. Unfortunately, these listening devices have several problems. First, when using a standard type listening device under the hood of a vehicle, the wind/noise generated from the cooling fan and other engine components interfere with hearing the sounds of various components that one is trying to listen to and diagnose. Furthermore, when listening to the internal sounds of the transmission, differential, chassis, engine, etc., it may be necessary to amplify the sounds and isolate certain frequencies that one is trying to diagnose.

Another problem with standard type listening devices is that it is difficult to get these devices near the component that needs to be listened to and diagnosed. Some engine components are in hard to reach areas. Many times it is difficult for a mechanic to position a listening device near these components. Furthermore, many components are near moving parts or parts with exposed electrical connections. It is difficult for present listening devices to get near these components without being damaged or destroyed by coming into contact with the moving parts.

Therefore, a need existed to provide an improved vehicle maintenance sensing device. The improved vehicle maintenance sensing device must be able to provide acoustical and vibration sensing of components and overcome the problems associated with prior art sensing devices.

### SUMMARY OF THE INVENTION

In accordance with one embodiment of the present invention, a diagnostic listening device for a vehicle is disclosed. The diagnostic listening device uses at least one input device to retrieve audible signals from the vehicle. Diagnostic circuitry is coupled to at least one input device. The diagnostic circuitry allows a user to listen to the audible signals retrieved and to isolate out certain frequencies to aid in the diagnosis of the vehicle.

In accordance with another embodiment of the present invention, a diagnostic listening device for a vehicle is disclosed. The diagnostic listening device uses a plurality of input devices to retrieve audible signals. Diagnostic circuitry is coupled to the plurality of input devices to allow a user to listen to the audible signals retrieved and to isolate out certain frequencies to aid in the diagnosis of the vehicle.

The present invention is best understood by reference to the following detailed description when read in conjunction with the accompanying drawings.

### BRIEF DESCRIPTION OF THE DRAWINGS

FIG. 1 is a perspective view of the diagnostic listening device of the present invention;

FIG. 2 is a back view of the diagnostic listening device of FIG. 1;

FIG. 3 is a simplified functional block diagram of the diagnostic circuitry used in the diagnostic listening device of the present invention;

FIG. 4 is a perspective view of the wand listening device used in the diagnostic listening device of the present invention;

FIG. 5 is a perspective view of the probe listening device used in the diagnostic listening device of the present I invention;

FIG. 6 is a perspective view of the clamp listening device used in the diagnostic listening device of the present invention;

FIG. 7 is a perspective view of the headphones used in the diagnostic listening device of the present invention.

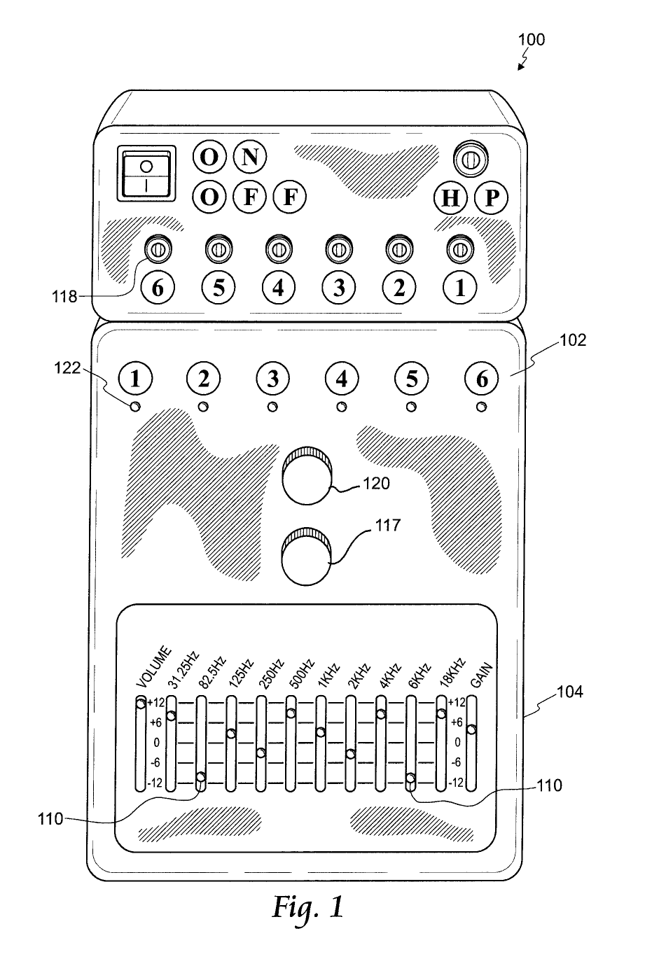

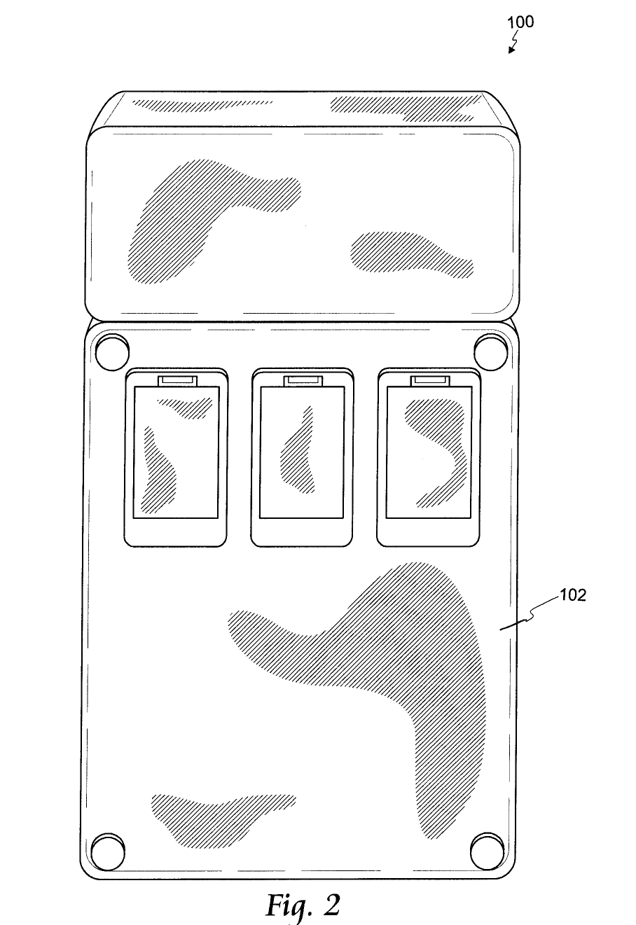

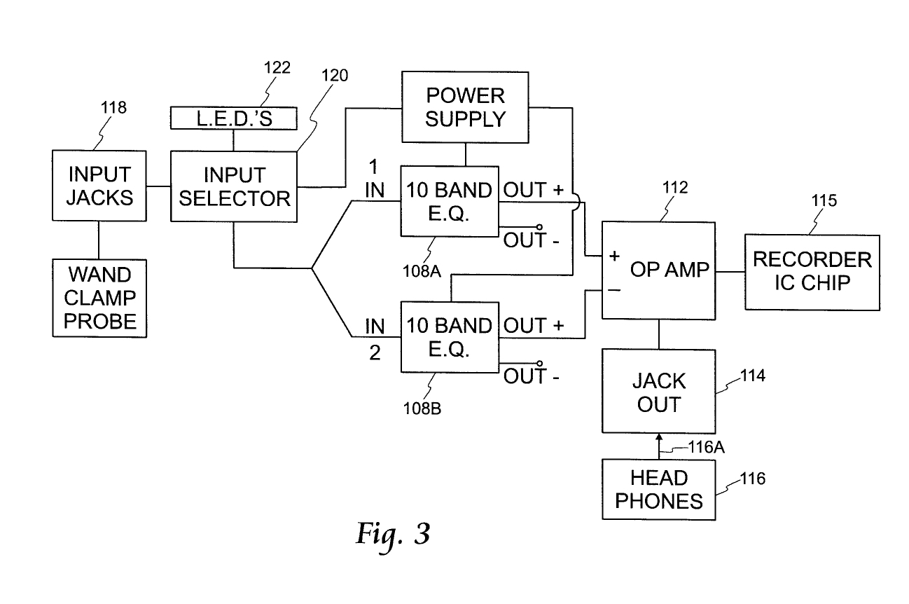

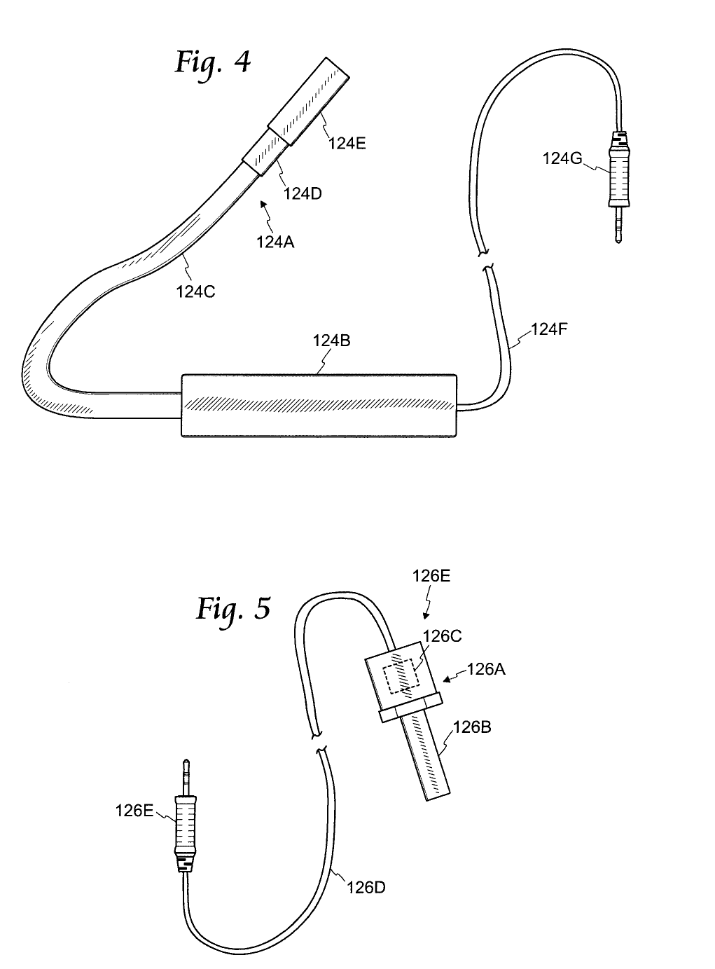

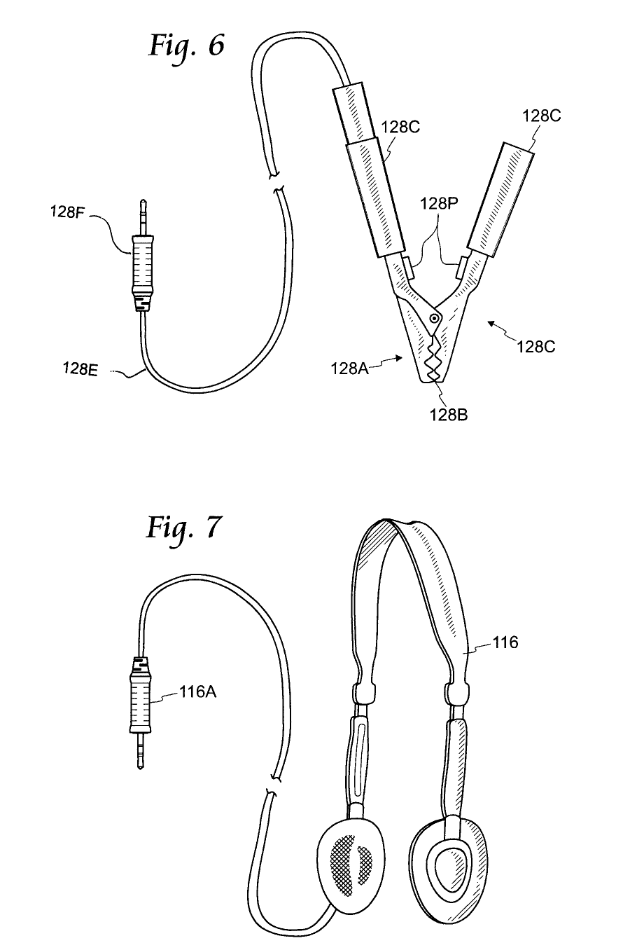

### DETAILED DESCRIPTION

Referring to the Figures, a diagnostic listening device 100 (hereinafter device 100) is shown. The device 100 allows a user to diagnose problems associated with the engine, transmission, differential, or other system of the vehicle by the ability to retrieve audio signals and vibration noises. The device 100 allows a user to isolate and filter out certain frequencies in order to aid in the diagnosis of the problem.

The device 100 has a control unit of 102. The control unit 102 has a housing 104. The housing 104 is used to protect a diagnostic circuitry 106. The diagnostic circuitry 106 allows a user to listen to a desired vehicle system for diagnosis while isolating out certain frequencies in order to aid in the diagnosis of the problem. By canceling out certain frequencies, a user may cancel out unwanted sounds in order to properly listen to the sounds of the system being diagnosed. The diagnostic circuitry 106 uses a pair of graphic equalizers 108A and 108B to achieve sound cancellation across the whole audio spectrum. This is accomplished by having a first graphic equalizer 108A 180 degrees out of phase with the second graphic equalizer 108B. This will allow one the first graphic equalizer 108A to cancel out the second graphic equalizer 108B. In the embodiment shown in the Figures, one of the graphic equalizers 108A or 108B will be internally mounted within the housing 104. The other graphic equalizer will then be mounted in the housing 104 such that the control switches 110 will be exposed on an outer surface of the housing 104. The pair of graphic equalizers 108A and 108B is coupled to a power supply 109. In the embodiment depicted in the Figures, the power supply 109 is a DC power source supplied by a battery. However, the power supply 109 may be an AC power supply, a DC power supply, or the like. The listing of the above power supplies are given as examples and should not be seen as to limit the scope of the present invention. The power supply 109 may be used to power other elements of the device 100.

The outputs of the graphic equalizers 108A and 108B are sent to an op amp 112. The op amp 112 is used to amplify the output signals from the graphic equalizers 108A and 108B. However, as stated above, since the first graphic equalizer 108A 180 degrees out of phase with the second graphic equalizer 108B only the non-cancelled frequencies of the sound signals will be sent to the op amp 112.

The output of the op amp 112 is sent to an output jack 114. The output jack 114 is used to removably connect a headphone 116, a speaker, or the like (hereinafter headphone) to the device 100. Alternatively, the headphone 116 may be hardwired to the output of the op amp 112. The headphone 116 is provided to allow a person using the device 100 to hear the audible signal retrieved by the device 100. In accordance with the embodiment depicted in the Figures, the headphone 116 has a connector jack 116A. The connector jack 116A of the headphone 116 allows the headphone 116 to be removably coupled to the output jack 114.

The op amp 112 may further be coupled to a recording device 115. The recording device 115 will allow a user to record the audible signals obtained by the device 100. The recording device 115 will have a playback button 115A to allow a user to replay the audible signals obtained by the device 100 so that the user can hear the recorded audible signals through the headphone 116.

The headphone jack 114 may further be coupled to a volume control knob 117. The volume control knob 117 will allow a user to control the level of the audible signal that is sent through the headphone jack 114.

The graphic equalizers 108A and 108B are coupled to one or more input jacks 118. In the embodiment depicted in the Figures, the device 100 has six (6) input jacks 118. However, this is shown for illustrative purposes and should not be seen as to limit the scope of the present invention. If multiple input jacks 118 are used, an input selector switch 120 is coupled to the input jacks 118 and the graphic equalizers 106. The input selector switch 120 will allow a user to select which input jack 118 will send an audible signal to the graphic equalizers 108A and 108B. A plurality of signaling devices 122 may be couples to the selector switch 110. The number of signaling devices 122 is generally equal to the number of input jacks 118. The signaling devices 122 will indicate which input jack 118 has been selected and is sending the audible signal to the graphic equalizers 108A and 108B. The signaling devices 122 may be a plurality of Light Emitting Diodes (LEDs), light bulbs, or the like. The above are given as examples and should not be seen as to limit the scope of the present invention.

A plurality of different input devices may be coupled to the input jacks 118. As shown in the Figures, the input devices may be a wand listening device 124, a probe listening device 126, a clamp listening device 128, or the like. The device 100 may use any number of the above input devices and any combination thereof. The number of input devices that the device 100 may use is only limited by the number of input jack 118.

As shown in the Figures, the wand listening device 124 is comprised of a body section 124A and a handle 124B. The body section 124A is generally comprised of a flexible wand member 124C. The flexible wand member 124C is made of flexible tubing. The flexible tubing must be rigid enough so that when the flexible wand member 124C is bent, the flexible wand member 124C will hold its shape. In accordance with one embodiment of the present invention, the flexible wand member 124C is made of a flexible metal conduit having non-conductive covering. The above is given as an example and should not be seen as to limit the scope of the present invention.

A microphone 124D is coupled to one end of the flexible wand member 124C. The microphone 124D is generally covered with a protective cover 124E. The cover 124E will protect the microphone 124D from dust, dirt, and moisture. The cover 124E will further filter wind noise while allowing other audible signals to pass.

One end of the handle 124B is coupled to the other end of the flexible wand member 124C opposite of the microphone 124D. The handle of 114B may have a cushioned grip to allow one to more easily and securely hold the wand listening device 114. The other end of the handle 124B is coupled to a first end of a cable 124F. The other end of the cable 124F is couple to an input jack 124G. The cable 124F is generally shielded cable. A shielded cable will prevent radio frequency (RF) interference with the audible signals picked up by the microphone 124D. The connector jack 124G allows the wand listening device 124 to be removable coupled to any of the input jack 118 of the device 100.

The probe listening device 126 is generally used to retrieve internal audible signals such as from the transmission, differential, and the like. The above is only given as an example and should not be seen as to limit the scope of the present invention. The probe listening device 126 has a probe member 126A. The probe member 126A has a casing 126B. The casing 126B may be tubing or the like. In accordance with one embodiment of the present invention, the casing 126B is tapered so that an inlet of the casing 126B is narrow than an opposite end. The tapered end allows the probe listening device 126 to be inserted into an area to be diagnosed. The casing 126B is used to house and protect an internal microphone 126C, electric condenser, or the like.

One end of the casing 126C is coupled to a first end of a cable 126D. A second end of the cable 126D is coupled to an input jack 126E. The cable 126D is generally shielded cable. A shielded cable will prevent radio frequency (RF) interference with the audible signals picked up by the microphone 126C. The input jack 126E allows the probe listening device 126 to be removable coupled to any of the input jack 118 of the device 100.

The clamp listening device 128 is used to retrieve audible signals from the frame, differential, and the like. The above is only given as an example and should not be seen as to limit the scope of the present invention. The clamp listening device 128 is comprised of a clamp unit 128A. The clamp unit 128A is similar to an alligator or battery clamp. The clamp unit 128A has a contact section 128B. The contact section 128B is used to attach the clamp listening device 128 to different systems/components to be diagnosed. A pair of handle members 128C extends down from the contact section 128B. By squeezing the handle members 128C, the contact section 128B will open thus allowing the contact section 128B to be placed on the system/component to be diagnosed. By releasing the handle members 128C, the contact section 128B will close thus securing the contact section 128B on the system/component to be diagnosed.

One or more sensors 128D are coupled to the clamp unit 128A. The sensors 128D are positioned where the handle members 128C extend down from the contact section 128B. In accordance with one embodiment, a pair of sensors 128D is used wherein an individual sensor 128D is positioned on each handle member 128C directly below where the handle members 128C extends down from the contact section 128B. The sensors 128D will thus pick-up audio signals from both jaws of the contact section 128B. The sensors 128D may be an electric condenser, microphone, pizzo elements, or the like.

One of the handle members 128C is coupled to a cable 128E. The other end of the cable 128E has an input jack 128F. The cable 128E is generally shielded cable. A shielded cable will prevent radio frequency (RF) interference with the audible signals picked up by sensors 128D. The input jack 128F allows the clamp listening device 128 to be removably coupled to any of the input jack 118 of the device 100.

Other input devices may be used without departing from the spirit and scope of the present invention. For example, a spider listening device may be used. A spider device has a plurality of listening devices coupled to one end of a cable. The listening devices may be an electric condenser, microphone, pizzo elements, or the like. The other end of the cable would have an input jack. Like the previous input devices, the cable is generally shielded cable. A shielded cable will prevent radio frequency (RF) interference with the audible signals picked up by the plurality of listening devices. The input jack allows the spider listening device to be removably coupled to any of the input jack 118 of the device 100.

In operation, one or more input devices are coupled to the input jacks 118. The input devices will be attached to different areas of the vehicle to be diagnosed. The input selector switch 120 will allow a user to select which input jack 118 will send an audible signal to the graphic equalizers 108A and 108B. The user of the device 100 will then use the control switches 110 of the graphic equalizers 108A or 108B to isolate out certain frequencies in order to aid in the diagnosis of the vehicle systems. By canceling out certain frequencies, a user may cancel out certain unwanted sounds in order to properly listen to the sounds of the system being diagnosed.

This disclosure provides exemplary embodiments of the present invention. The scope of the present invention is no limited by these exemplary embodiments. Numerous variations, whether explicitly provides for by the specification or implied by the specification, such as variations in structure, dimension, type of material and manufacturing process may be implemented by one of the skill in the art in view of this disclosure.

What is claimed is:

1. A diagnostic listening device for a vehicle comprising:
at least one input device to retrieve audible signals; and
diagnostic circuitry coupled to the at least one input device to allow a user to listen to the audible signals retrieved and to isolate out certain frequencies to aid in the diagnosis of the vehicle.

2. A diagnostic listening device for a vehicle in accordance with claim 1 further comprising a listening device coupled to the diagnostic circuitry.

3. A diagnostic listening device for a vehicle in accordance with claim 1 further comprising a housing for storing the diagnostic circuitry.

4. A diagnostic listening device for a vehicle in accordance with claim 1 wherein the diagnostic circuitry comprises at least one graphic equalizer, the at least one input device coupled to the at least one graphic equalizer, the at least one graphic equalizer allowing a user to isolate out certain frequencies.

5. A diagnostic listening device for a vehicle in accordance with claim 1 wherein the diagnostic circuitry comprises:
a pair of graphic equalizers, wherein a first graphic equalizer is out of phase with a second graphic equalizer, the at least one input device coupled to the pair of graphic equalizers, the pair of graphic equalizers allowing a user to isolate out certain frequencies; and
a power supply coupled to the pair of graphic equalizers.

6. A diagnostic listening device for a vehicle in accordance with claim 5 wherein the diagnostic circuitry further comprises at least one input jack coupled to the pair of graphic equalizers for removably attaching the at least one input device to the diagnostic circuitry.

7. A diagnostic listening device for a vehicle in accordance with claim 5 wherein the diagnostic circuitry further comprises:
an op amp coupled to the pair of graphic equalizers; and
an output jack coupled to an output of the op amp.

8. A diagnostic listening device for a vehicle in accordance with claim 6 wherein the diagnostic circuitry further comprises a recording device coupled to the op amp to record the audible signals sent to the op amp from the pair of graphic equalizers.

9. A diagnostic listening device for a vehicle comprising:
a plurality of input devices to retrieve audible signals; and
diagnostic circuitry coupled to the plurality of input devices to allow a user to listen to the audible signals retrieved and to isolate out certain frequencies in to aid in the diagnosis of the vehicle.

10. A diagnostic listening device for a vehicle in accordance with claim 8 further comprising a listening device coupled to the diagnostic circuitry.

11. A diagnostic listening device for a vehicle in accordance with claim 8 wherein the diagnostic circuitry comprises:
at least one graphic equalizer, the at least one input device coupled to the at least one graphic equalizer, the at least one graphic equalizer allowing a user to isolate out certain frequencies;
a plurality of input jacks to allow the plurality of input devices to be removable attached to the diagnostic circuitry; and
a selector switch coupled to the plurality of input jacks.

12. A diagnostic listening device for a vehicle in accordance with claim 10 wherein the diagnostic circuitry further comprises a plurality of indicators coupled to the selector switch to indicate which of the plurality of input jacks is active.

13. A diagnostic listening device for a vehicle in accordance with claim 10 wherein the diagnostic circuitry further comprises:
an op amp coupled to the at least one graphic equalizer; and
an output jack coupled to an input of the op amp.

14. A diagnostic listening device for a vehicle in accordance with claim 12 wherein the diagnostic circuitry further comprises a recording device coupled to the op amp to record the audible signals sent to the op amp from the at least one graphic equalizer.

15. A diagnostic listening device for a vehicle in accordance with claim 8 wherein the diagnostic circuitry comprises:
a pair of graphic equalizers, wherein a first graphic equalizer is out of phase with a second graphic equalizer, the at least one input device coupled to the pair of graphic equalizers, the pair of graphic equalizers allowing a user to isolate out certain frequencies.
at least one input jacks coupled to the pair of graphic equalizers for removably attaching the at least one input device to the diagnostic circuitry;
a selector switch coupled to the plurality of input jacks; and
a power supply coupled to the pair of graphic equalizers.

16. A diagnostic listening device for a vehicle in accordance with claim 14 wherein the diagnostic circuitry further comprises:
an op amp coupled to the pair of graphic equalizers; and
an output jack coupled to an output of the op amp.

17. A diagnostic listening device for a vehicle in accordance with claim 15 wherein the diagnostic circuitry further comprises a recording device coupled to the op amp to record the audible signals sent to the op amp from the pair of graphic equalizers.

18. A diagnostic listening device for a vehicle in accordance with claim 8 wherein the plurality of input devices comprises at least one wand listening device comprising:
a body section;
a listening device coupled to one end of the body section;
a protective cover coupled to the listening device;
a handle having a first end coupled to the body section; and
a cable having a first end coupled to a second end of the handle and a second end coupled to a connector jack.

19. A diagnostic listening device for a vehicle in accordance with claim 8 wherein the plurality of input devices comprises at least one probe listen device, the probe listening device comprising:
a tapered casing;
a listening device housed in the tapered casing; and
a cable having a first end coupled to the tapered casing and a second end coupled to a connector jack.

20. A diagnostic listening device for a vehicle in accordance with claim 8 wherein the plurality of input devices comprises at least on clamp listen device, the clamp listening device comprising:
a clamp unit;
a pair of handle members extending down from the clamp unit;
a pair of listening sensors, wherein an individual listening sensor is positioned on each handle member directly below where the handle members 128C extends down from the clamp unit; and
a cable having a first end coupled to one of the pair of handles and a second end coupled to a connector jack.
